(19) United States
(12) Patent Application Publication
(10) Pub. No.: US 2010/0143555 A1
(43) Pub. Date: Jun. 10, 2010

(54) 5-LAYER BARRIER FILM, SEALING PROCESS AND USE THEREOF FOR PACKAGING FOOD

(75) Inventor: Josyane Bonetti, Quimper (FR)

Correspondence Address: Pepper Hamilton LLP, 400 Berwyn Park, 899 Cassatt Road, Berwyn, PA, 19312-1183, US

(73) Assignee: BOLLORE, Ergue Gaberic (FR)

(21) Appl. No.: 12/527,890

(22) PCT Filed: Aug. 20, 2008
(86) PCT No.: PCT/EP08/52032

§ 371 Date: Nov. 18, 2009

(30) Foreign Application Priority Data
Feb. 21, 2007 (FR) 07/01218

(51) Int. Cl. B32B 27/08; B32B 27/32; B65B 31/00; B65D 81/00; B32B 27/34; B32B 27/30; C08J 5/18; B65B 51/10; B65B 31/02

(52) U.S. Cl. 426/415; 428/474.4; 428/216; 428/220; 428/339; 53/432; 53/477

(57) ABSTRACT

The invention relates to a barrier film made up of five stacked layers comprising: a central barrier layer comprising a first blend of EVOH and of PA, two outer layers comprising a second blend, and two adhesive layers between the central layer and the two outer layers, wherein the second blend only contains a first copolymer of ethylene and of an a-olefin having a density less than or equal to 0.925 g/cm³ and greater than or equal to 0.915 g/cm³ and a second metallocene copolymer of ethylene and of an a-olefin having a density less than or equal to 0.910 g/cm³.

The invention relates to a barrier film made up of five layers, comprising a central barrier layer based on EVOH.

Barrier films are used in the field of packaging of foodstuffs under a modified atmosphere.

For this purpose EVOH (ethylene-vinyl alcohol copolymer) is known for its good properties of imperviousness to gas, notably to oxygen.

In order to ensure the tightness of the package, the barrier film should be able to be sealed by heating.

Therefore a sealing layer is provided for either one or both of the outer layers of the film.

An intermediate layer is provided in order to have each outer layer adhere to the barrier layer and ensure resistance to de-stratification of the film.

Such a five-layer structure allows low thickness films to be made with low cost of materials as compared with films with six, seven layers and more.

Different five-layer films are known.

Document EP-B-561 428 describes a film comprising:
a core layer comprising EVOH mixed with polyamide,
adhesive intermediate layers, comprising a polyolefin modified with an acid or an acid anhydride,
outer layers comprising a blend of LLDPE and of VLDPE.

Document EP-B-217 596 relates to a film including:
a core layer containing a blend of EVOH and polyamide,
two inner adhesive layers of polymer modified with an acid or an acid anhydride,
two outer layers comprising a blend with three components, LLDPE, LMDPE and EVA.

Document EP-B-881 966 relates to a film having
a core layer with EVOH
two outer layers, at least one of which contains a three-component blend:
a component A of homogenous or heterogeneous ethylene and α-olefin copolymer with a density comprised between 0.915 and 0.925 g/cm³,
a component B of homogeneous or heterogeneous ethylene and α-olefin copolymer with a density greater than or equal to 0.925 g/cm³,
a component C of homogeneous or heterogeneous ethylene and α-olefin copolymer with a density less then or equal to 0.915 g/cm³,
two adhesive layers between the core layer and the outer layers.

Document EP-B-369 808 relates to a film comprising:
a heat-sealing VLDPE layer of less than 920 kg/cm³,
a barrier layer in PVDC or EVOH,
a thermoplastic outer layer, selected from LLDPE of more than 920 kg/m³, high density linear PE, EVA copolymers, copolymers of ethylene and alkyl acrylate with 1-8 carbon atoms, ethylene and acrylic acid copolymers and ionomeric polymers,
an intermediate VLDPE layer between the barrier layer and the thermoplastic outer layer,
an additional thermoplastic layer between the heat-sealing layer in VLDPE and the barrier layer, selected from LLDPE of more than 920 kg/m³, high density linear PE, EVA copolymers, copolymers of ethylene and alkyl acrylate with 1-8 carbon atoms, ethylene and acrylic acid copolymers and ionomeric polymers.

The barrier films have to meet many requirements.

The seals should have some mechanical strength so as to allow the packaged product to be handled and stored.

It is desired that these seals may be made with a machine at a relatively low temperature, in order to increase rates of the sealing stations on a packaging line and in order to save energy.

When the film has to pass into shrinkage ovens, free shrinkage of the film should be large at low temperature, in order to preserve the packaged foodstuffs, shorten this time spent in these ovens and improve productivity.

The seals should be heat-resistant for pasteurization purposes in order to allow the film to pass into a water bath at 85° C. for one hour and a half without weakening the strength of the seals.

When the foodstuff is unpacked, the film should be able to be peeled off at the seals.

Thus, the seals have to be resistant, but nevertheless peelable upon opening by the user.

The known films indicated above do not or only partly meet either one of these requirements.

The invention is directed to obtaining a barrier film meeting these requirements, in particular as regards the seal.

For this purpose, a first object of the invention is a barrier film made up with five superposed layers, comprising:
a central barrier layer comprising a first blend of ethylene-vinyl alcohol copolymer in majority by weight and of polyamide,
two outer layers comprising a second blend of copolymers of ethylene and α-olefins,
two adhesive layers between the central layer and the two outer layers, respectively,

characterized in that

the second blend of copolymers of ethylene and α-olefins of at least one of the outer layers only contains a first copolymer of ethylene and of an α-olefin having a density less than or equal to 0.925 g/cm³, and greater than or equal to 0.915 g/cm³ and a second metallocene copolymer of ethylene and of an α-olefin having a density less than or equal to 0.910 g/cm³.

According to other features of the invention:
the first copolymer of the second blend is LLDPE.
the proportion of the first copolymer for example formed with LLDPE, relatively to the weight of its outer layer, is greater than or equal to 40%.
the proportion of the second copolymer relatively to the weight of its outer layer is greater than or equal to 20% and less than or equal to 45%, and notably greater than or equal to 35%.
the second copolymer of the second blend has a density less than or equal to 0.905 g/cm³.
each outer layer contains said second blend of copolymers of ethylene and α-olefins.
the barrier layer has a thickness greater than or equal to 4 micrometers.

The film is for example symmetrical relatively to the central barrier layer.

In an embodiment, the first blend of the barrier layer contains at least 80% by weight of EVOH, and preferably at least 90% by weight of EVOH.

In an embodiment, the first blend of the barrier layer comprises copolyamide 6/6-6. For example, the first blend is 90% by weight of EVOH and 10% by weight of copolyamide 6/6-6.

In another embodiment the first blend of the barrier layer comprises terpolyamide 6/6-6/12. The proportion of terpolyamide 6/6-6/12 in the first blend of the barrier layer may be less than 9%. For example, the first blend is 92% by weight of EVOH and 8% by weight of terpolyamide 6/6-6/12.

LLDPE is low density linear polyethylene, i.e. with a density less than or equal to 0.925 g/cm³ and greater than or equal to 0.915 g/cm³.

LLDPE-g-MAH is the LLDPE grafted with maleic anhydride.

LDPE is low density ethylene homopolymer.

One and/or the other of the intermediate layers comprises polyethylene grafted with maleic anhydride, such as for example LLDPE grafted with maleic anhydride. Each intermediate layer has a thickness of at least 2 micrometers.

In an embodiment, the percentage of the thickness of the layers relatively to the total thickness of the film is the following:

30%/10%/20%/10%/30%.

The invention will be better understood upon reading the description which follows, only given as an exemplary non-limiting embodiment with reference to the appended drawings, wherein:

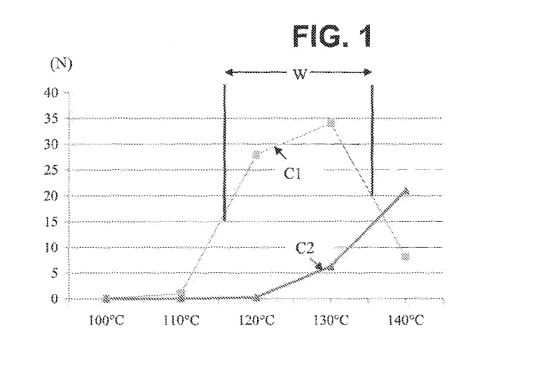

FIG. 1 is a diagram showing the value of the strength of a sealing carried out on a film according to the invention versus temperature, and

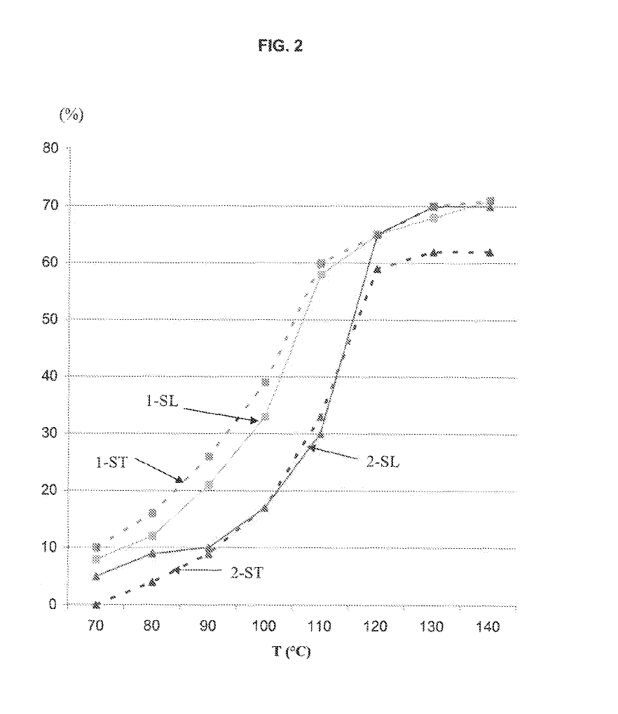

FIG. 2 is a diagram showing the value of the shrinkage rate of a film according to the invention versus temperature.

An exemplary embodiment of the film according to the invention, called Example 1 herein below, has the following structure:
a barrier layer of a thickness of 5 micrometers, formed with 90% by weight of an EVOH having a density of 1.14 g/cm³ and a melting point of 161° C.-165° C. and with 10% by weight of copolyamide 6/6-6 having a density of about 1.13 g/cm³, and a melting point at 192° C.,
two intermediate layers each with a thickness of 2.5 micrometers, each formed with an LLDPE-g-MAH, with a density of 1.14 g/cm³ and a melting point at 161° C.,
two outer layers each with a thickness of 7.5 micrometers, formed with 46% by weight of an LLDPE having a density of 0.916 g/cm³ and a melting point at 122° C., with 40% by weight of a metallocene copolymer of ethylene and α-olefin with a density of 0.902 g/cm³ and a melting point at 95° C., with 8% by weight of an antifog composition and with 6% by weight of an antiblocking agent.

The antifog composition is a master-batch having 10% of an antifog agent on a LDPE support, i.e. the 8% of added antifog composition provide 0.8% of active antifog agent and 7.2% of supporting LDPE at 0.920 g/cm³ by weight in the layer.

The antiblocking composition is a master-batch having 5% of synthetic silica on an LDPE support, i.e. the 6% of the added antiblocking composition provide 0.3% of synthetic silica and 5.7% of supporting LDPE at 0.920 g/cm³ by weight in the layer.

This film is for example made by a double bubble process during which a cylindrical sheath is produced, as this is known by one skilled in the art. The double bubble process takes place in the following way: a first cylindrical sheath, called a primary sheath, is soaked in water so as to be cooled, and then conveyed to a height, for example a height of 20 meters. It is then heated up in ovens in order to attain a determined orientation temperature. Next, the sheath is inflated by air injected from below. The thereby obtained bubble is closed from below by nips and is cut on two sides by two blades in order to obtain two separate films, which are wound onto rolls. The film has a longitudinal direction or machine direction, which is its direction of winding onto the roll during its manufacturing and a transverse direction parallel to the axis of the roll.

A comparative exemplary film 2 is a barrier film of the state of the art having reference BDF 8050 from Cryovac.

The method used for measuring the seal strength of a film was carried out by sealing two elements of this film and evaluating its peel strength. The seals were made at different temperatures with a same machine of the known Brugger type, with a force exerted by the sealing bars on the film of 120 N for 0.7 seconds. The tensile breaking force was measured at a constant rate (150 mm/min) of a test specimen consisting of two film elements sealed perpendicularly to their length. The width of the test specimen is 30 mm+ or −0.5 mm. The breaking force has to be expressed with respect to the width of the sealed test specimen. The indicated values in N are specifically in Newtons/30 mm.

FIG. 1 illustrates the seal strength in N in ordinates, measured for different sealing temperatures in ° C. in abscissae for Example 1 of the film according to the invention according to curve C1 (formed with squares) and for Example 2 of the film of the state of the art according to curve C2 (formed with triangles).

The seal strength of the exemplary film 1 according to the invention is great from 115° C. to 135° C. and is greater for these temperatures than the one of the known Example 2, thereby forming at these temperatures a very low sealability window W (defined by a seal strength above an initiation threshold from 15-20 N), which will allow high rates on packaging machines. In this window, the seals are peelable. The initiation seal temperature is less than 120° C.

Above 135° C., the film de-stratifies.

The sealability window of the known Example 2 is located between 140 and 160-170° C. In this window, Example 2 de-stratifies systematically.

T._{SIT}=Seal initiation temperature=115° C. for Example 1 according to the invention.

T._{SIT}=Seal initiation temperature=140° C. for the known Example 2.

Other seals were made on a machine of the Flowpack type (heat-welded envelope) from Ulma, and their strength was measured according to the method indicated earlier, which gave the results indicated in the table below.

| | Example 1 according to | | Example 2 according to | |
|---|---|---|---|---|
| Flowpack | the invention | | the state of the art | |
| Sealing bar | 125 or 130 | | 160 | |
| temperature | | | | |
| (° C.) | | | | |
| Knurling tool | 130 | | 160 | |
| temperature | | | | |
| (° C.) | | | | |
| Shrinkage oven | 160 | | 160 | |
| temperature (° C.) | | | | |
| Residence time in | 4 | | 7 | |
| shrinkage oven (in | | | | |
| seconds) | | | | |
| Sealing direction | SL = knurl | ST = Bar | SL = knurl | ST = Bar |
| | (1-SL) | (1-ST) | (1-SL) | (1-ST) |
| Seal strength (N) | 15 | 15 | 18 | 20 |

| | | |
|---|---|---|
| Comments | Clean peeling | Interlayer |
| | | de-stratification |

SL is the longitudinal sealing direction. ST is the transverse sealing direction. Example 1 according to the invention is able to be sealed at very low temperatures and to pass very rapidly in the shrinkage oven because of its high shrinkage rate at low temperature, as this is shown in FIG. 2 (25% at 93° C. versus 12% for Example 2). The temperature of the sealing bars may therefore be advantageously reduced by a value comprised between 35° C. and 40° C. The temperature of the shrinkage oven for the film according to the invention may be 160° C. with an increase in the passage rate in the oven by 70%. The shrinkage rate of Example 1 was 13-15% per second, versus 9.5% for Example 2.

The strength of the seals of the Flowpack type was also measured under pasteurization conditions indicated in the table below.

| | Sealing direction | | | |
|---|---|---|---|---|
| | 1-SL = | | | 2-ST = |
| | knurl | 1-ST = bar | 2-SL = knurl | bar |
| Seal strength after | 13.2 | 15 | 12.8 | 22.4 |
| 1 h 30 min in a water | | | | |
| bath at 85° C. (N) | | | | |

| | | |
|---|---|---|
| Comments | Clean peeling | Interlayer |
| | | de-stratification |

The passage in the water bath for one hour and thirty minutes did not weaken the seals of the Flowpack packages.

The seals of Example 1 according to the invention are peelable at low temperature without

de-stratification of the film, unlike Example 2.

According to the features of the invention:
the seal initiation temperature for a seal breaking force greater than or equal to 15 N/30 mm is lower than 120° C.;
the sealability window for a seal breaking force greater than or equal to 10 N/30 mm comprises the range extending from 115° C. to 135° C.;
the sealability window for a seal breaking force greater than or equal to 15 N/30 mm comprises the range extending from 115° C. to 135° C.;
the seal breaking force of the film is greater than or equal to 10 N/30 mm after passing in the water bath for one hour and a half at 85° C.;
the modulus of elasticity is greater than or equal to 700 MPa;
the permeability to oxygen at a humidity rate of 0% and at 23° C. is less than or equal to 20 cm³/m²/24 hours;
the permeability to oxygen at a humidity rate of 80% and at 23° C. is less than or equal to 25 cm³/m²/24 hours;
the film has a total thickness less than or equal to 30 micrometers.

The modulus of elasticity of Example 1 is sufficiently large between 700 and 800 MPa, while having a film which is sealable at low temperature.

The oxygen transmission rate (OTR) was measured according to the table below, for a barrier layer thickness measured to be 4.7 micrometers for Example 1 and for a barrier layer thickness measured to be 3.2 micrometers for Example 2.

| Permeability to oxygen | At a humidity rate of | At a humidity rate of |
|---|---|---|
| (in cm³/m²/24 hours) | 0% and at 23° C. | 80% and at 23° C. |
| Example 1 | 16.6 | 20.8 |
| Example 2 | 23.8 | 28.5 |

In the case when the barrier layer of example 1 contains instead of 10% copolyamide, 8% of terpolyamide 6/6-6/12 as indicated above, the oxygen transmission rate is the following for a barrier layer thickness measured to be 4.1 micrometers.

| Permeability to oxygen | At a humidity rate of | At a humidity rate of |
|---|---|---|
| (in cm³/m²/24 hours) | 0% and at 23° C. | 80% and at 23° C. |
| Example 1 with | 16.4 | 20 |
| terPA6/6-6/12 | | |

By adding terPA as a lower rate than coPA (8% versus 10%), it is possible to obtain better stretchability of the film (improved processability) without degrading the barrier property.

The object of the invention is also a method for sealing at least two walls of a package, the walls being made up of the film as described above, comprising at least one step for applying on the walls at least one heating protruding element for their sealing,

characterized in that

the temperature of the sealing element is less than or equal to 130° C.

According to features of the invention:
the step for applying the sealing element is followed by at least one step for passing into at least one shrinkage oven with a residence time in the shrinkage oven less than or equal to 4 seconds at a temperature of the shrinkage oven greater than or equal to 150° C.,
the shrinkage rate of the film is greater than or equal to 10% per second.

An exemplary application of the method described above is the sealing of a package of a food product under a modified atmosphere.

1. A barrier film comprising five superposed layers, comprising:
a central barrier layer comprising a first blend of an ethylene-vinyl alcohol copolymer in majority by weight and of polyamide;
two outer layers comprising a second blend of copolymers of ethylene and α olefins; and
two adhesive layers between the central layer and the two outer layers, respectively;
characterized in that:
the second blend of copolymers of ethylene and α-olefins of at least one of the outer layers, only contains a first copolymer of ethylene and of an α-olefin having a density less than or equal to 0.925 g/cm³, and greater than or equal to 0.915 g/cm³, and a second metallocene copolymer of ethylene and of an α-olefin having a density less than or equal to 0.910 g/cm³;
the proportions of the second copolymer relative to the weight of its outer layer being greater than or equal to 20% and less than or equal to 45%;
the seal initiation temperature for a sealing breaking force greater than or equal to 15 N/30 mm being lower than 120° C.; and
the seal breaking force of the film being greater than or equal to 10 N/30 mm after passing in a water bath for one hour and a half at 85° C.

2. The film according to claim 1, characterized in that the first copolymer of the second blend is low density linear polyethylene (LLDPE).

3. The film according to claim 1, characterized in that the proportion of the first copolymer relative to the weight of the outer layer, is greater than or equal to 40%.

4. The film according to claim 1, characterized in that the proportion of the second copolymer relative to the weight of its outer layer, is greater than or equal to 35%.

5. The film according to claim 1, characterized in that the second copolymer of the second blend has a density less than or equal to 0.905 g/cm³.

6. The film according to claim 1, characterized in that each outer layer contains said second blend of copolymers of ethylene and α-olefins.

7. The film according to claim 1, characterized in that the first blend of the barrier layer contains at least 80% by weight of ethylene-vinyl alcohol copolymer (EVOH).

8. The film according to claim 1, characterized in that the first blend of the barrier layer comprises copolyamide 6/6-6.

9. The film according to claim 1, characterized in that the first blend of the barrier layer comprises terpolyamide 6/6-6/12.

10. The film according to claim 9, characterized in that the proportion of terpolyamide 6/6-6/12 in the first blend of the barrier layer is less than 9%.

11. The film according to claim 1, characterized in that at least one of the intermediate layers comprises polyethylene grafted with maleic anhydride.

12. The film according to claim 1, characterized in that at least one of the intermediate layers comprises low density linear polyethylene (LLDPE) grafted with maleic anhydride.

13. The film according to claim 1, characterized in that each intermediate layer has a thickness of at least 2 micrometers.

14. The film according to claim 1, characterized in that the sealability window for a seal breaking force greater than or equal to 10 N/30 mm comprises the range extending from 115° C. to 135° C.

15. The film according to claim 1, characterized in that the sealability window for a seal breaking force greater than or equal to 15 N/30 mm comprises the range extending from 115° C. to 135° C.

16. The film according to claim 1, characterized in that the modulus of elasticity is greater than or equal to 700 MPa.

17. The film according to claim 1, characterized in that the permeability to oxygen at a humidity rate of 0% and at 23° C. is less than or equal to 20 cm³/m²/24 hours.

18. The film according to claim 1, characterized in that the permeability to oxygen at a humidity rate of 80% and at 23° C. is less than or equal to 25 cm³/m²/24 hours.

19. The film according to claim 1, characterized in that it is symmetrical relative to the central barrier layer.

20. The film according to claim 1, characterized in that it has a total thickness less than or equal to 30 micrometers.

21. The film according to claim 1, characterized in that the barrier layer has a thickness greater than or equal to 4 micrometers.

22. A method for sealing at least two walls of a package comprising:
applying on the walls at least one heating protruding element for their sealing, characterized in that the temperature of the heating protruding element is less than or equal to 130° C.;
wherein the at least two walls of the package are made up of a barrier film comprising five superposed layers, comprising:
a central barrier layer comprising a first blend of an ethylene-vinyl alcohol copolymer in majority by weight and of polyamide;
two outer layers comprising a second blend of copolymers of ethylene and α-olefins; and
two adhesive layers between the central layer and the two outer layers, respectively;
wherein:
the second blend of copolymers of ethylene and α-olefins of at least one of the outer layers, only contains a first copolymer of ethylene and of an α-olefin having a density less than or equal to 0.925 g/cm³, and greater than or equal to 0.915 g/cm³, and a second metallocene copolymer of ethylene and of an α-olefin having a density less than or equal to 0.910 g/cm³;
the proportions of the second copolymer relative to the weight of its outer layer being greater than or equal to 20% and less than or equal to 45%;
the seal initiation temperature for a sealing breaking force greater than or equal to 15 N/30 mm being lower than 120° C.; and
the seal breaking force of the film being greater than or equal to 10 N/30 mm after passing in a water bath for one hour and a half at 85° C.

23. The method according to claim 22 further comprising passing the package into at least one shrinkage oven with a residence time in the shrinkage oven less than or equal to 4 seconds at a temperature of the shrinkage oven greater than or equal to 150° C.

24. The method according to claim 23, characterized in that the shrinkage rate of the film is greater than or equal to 10% per second.

25. The method according to claim 22 wherein the package comprises a food product under a modified atmosphere.
